(19) United States
(12) Patent Application Publication
(10) Pub. No.: US 2012/0330713 A1
(43) Pub. Date: Dec. 27, 2012

(54) SYSTEM AND METHOD FOR OPTIMIZING A MEDIA PURCHASE

(75) Inventors: Craig W. Kowalchuk, Aurora (CA); Sheldon H. Smith, Toronto (CA); David Diamond, New York, NY (US)

(73) Assignee: Twenty-Ten, Inc., Toronto (CA)

(21) Appl. No.: 13/167,899

(22) Filed: Jun. 24, 2011

(51) Int. Cl. G06Q 10/00

(52) U.S. Cl. 705/7.29

(57) ABSTRACT

A method. The method is implemented at least in part by a computing device. The method includes matching information in a first database with corresponding entries in a second database, utilizing a targeting engine to calculate a score for at least a portion of the consumers in the first database, and ranking at least a portion of the consumers in the first database based on the calculated scores. The second database is larger than the first database. The method also includes comparing media behavior of a first group of ranked consumers in the first database with media behavior of a second group of consumers in the first database. The matching, calculating, ranking and comparing are performed by the computing device.

### CROSS-REFERENCE TO RELATED APPLICATION

This application is related to U.S. patent application Ser. No. 13/020,967, to U.S. patent application Ser. No. 12/869,441, to U.S. patent application Ser. No. 12/340,244, now U.S. Pat. No. 7,835,940, to U.S. patent application Ser. No. 10/821,516, now U.S. Pat. No. 7,742,072, and to U.S. patent application Ser. No. 09/511,971, now abandoned.

### BACKGROUND

This application discloses an invention which is related, generally and in various embodiments, to a system and method for optimizing a media purchase. The invention is especially useful for identifying optimal consumers for prospecting.

In the quest for new business opportunities, there has been a growing proliferation of products and services seeking to more relevantly satisfy consumer needs. This has heightened competition and furthered a desire by marketers to look for tools that can more precisely identify optimal groups of consumers. Typical targeting methods have used historical information to determine what type of consumer had previously used product/service categories or brands. These factors were used to predict which consumers would likely buy in the future.

With respect to targeting optimal groups of consumers through mass media, the majority of the previous approaches have restricted advertisers to using demographic factors or proxies. One approach has been to administer a survey to measure consumer media usage behaviors. The surveys have also been utilized to gather general demographic information for each respondent. Marketers with specific demographic targets (e.g., women 25-54 years old) then conduct analysis to understand which media best delivers that particular demographic audience.

Unfortunately, a targeting method based on demographics has several drawbacks. For example, the demographic-based targeting method assumes that all consumers within the defined demographic sub-set are equally attractive. As such, this method typically does not distinguish between individual consumers within the same group. In addition, this method does not consider attitudinal variables, even though attitudinal variables greatly influence the future purchasing behavior of consumers. Because of these drawbacks, demographic-based media targeting techniques often do not meet the financial needs or specific marketing objectives of marketers.

To enhance the results generally achieved from the traditional targeting methodologies, some direct marketers have also begun to use attitudinal filtering. Attitudinal filtering is utilized to identify and reach groups of consumers who tend to “think alike” with respect to their brand preference and market segment. Examples of such groups, which are divided based on attitudinal variables, include early adopters of high tech consumer products, risk-averse buyers of investment securities, prestige-seeking buyers of luxury automobiles, fashion conscious clothes buyers, etc. Various examples of attitudinal filtering are described, for example, in U.S. Pat. No. 7,742,072, assigned to the assignee of the instant patent application.

The grouping of potential customers using attitudinal characteristics and/or definitions results in segments defined by more than mere demographics and/or behaviors. For example, rather than creating a group of potential luxury car buyers based solely on demographic information like income and past purchases, attitudinally-based segments look to the reasons for purchasing behavior. In this example, instead of merely identifying a group of potential luxury car buyers based on their higher income level, the use of attitudinal filtering allows for the grouping of potential luxury car buyers based on the reason for wanting to purchase a luxury car (e.g., seeking prestige, professional appearance, etc.).

However, prospective advertisers are still targeting their media purchases based on demographics and have been unable to target their media purchases on the basis of a custom attitudinal profile. Thus, advertisers still face the difficulty of accurately determining which available media purchases (e.g., a given newspaper, a given magazine, a given radio show, a given television show, etc.) would provide the most effective return on their investment.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1; and

FIG. 3 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

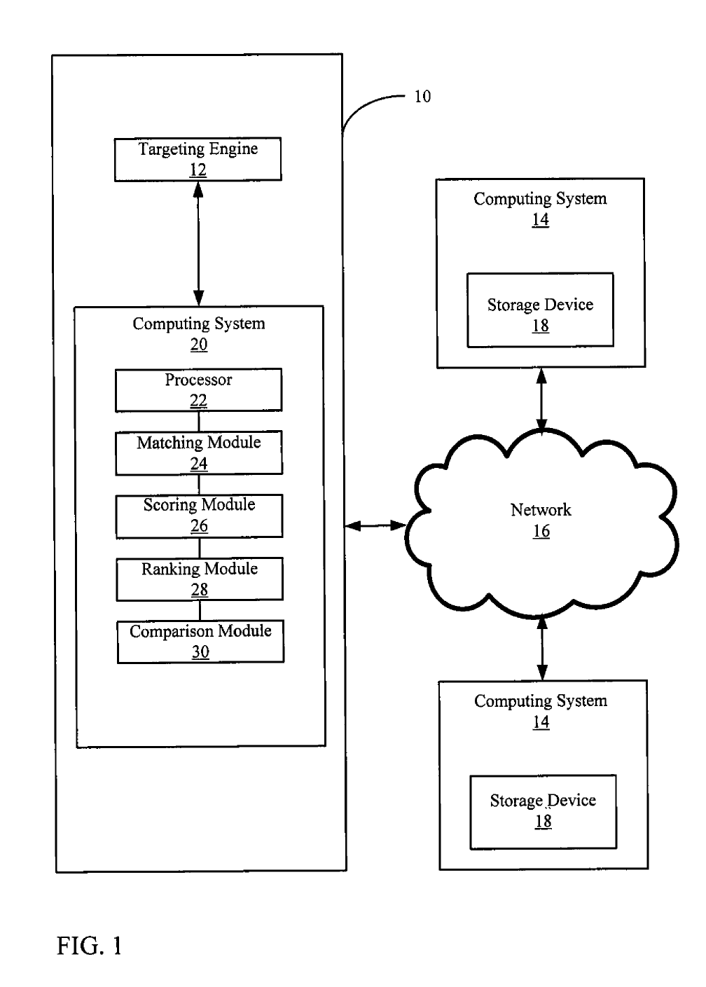

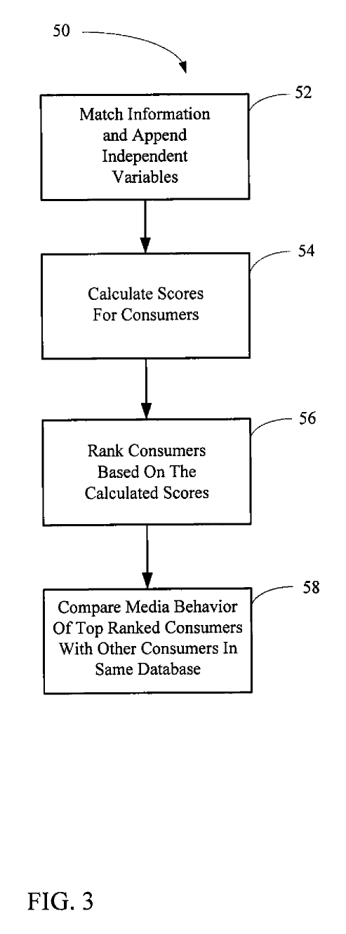

FIG. 1 illustrates various embodiments of a system 10. As explained in more detail hereinbelow, the system 10 may utilize one or more algorithms generated by a targeting engine 12 to provide guidance to an entity (e.g., an advertiser) considering one or more media purchases. The targeting engine 12 may be embodied, for example, as any of the targeting engines described in U.S. patent application Ser. No. 13/020,967 (e.g., the modules of the system 30 shown in FIG. 3 thereof), in U.S. patent application Ser. No. 12/869,441 (e.g., the modules of the system 10 shown in FIG.1 thereof), in U.S. patent application Ser. No. 09/511,971, in U.S. Pat. No. 7,835,940 and in U.S. Pat. No. 7,742,072, the contents of which are hereby incorporated by reference in their entirety. Each of the patents/patent applications listed above are assigned to the assignee of the instant application. Conceptually, the system 10 can be thought of as a layer on top of the targeting engine 12. According to various embodiments, the system 10 is separate from the targeting engine 12. According to other embodiments, the system 10 is separate from but communicably connected to the targeting engine 12. According to yet other embodiments, the system 10 incorporates the targeting engine 12 therein.

As shown in FIG. 1, the system 10 may be communicably connected to a plurality of computing systems 14 via one or more networks 16. Each of the one or more networks 16 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 16 may include elements, such as, for example, intermediate nodes, proxy servers, routers, switches, and adapters configured to direct and/or deliver data. In general, the system 10 may be structured and arranged to communicate with the computer systems 14 via the one or more networks 16 using various communication protocols (e.g., HTTP, TCP/IP, UDP, WAP, WiFi, Bluetooth) and/or to operate within or in concert with one or more other communications systems.

Each of the computing systems 14 may include any number of computing devices communicably connected to one another. The system 10 may also be communicably connected to a plurality of storage devices 18. According to various embodiments, the system 10 is communicably connected to the storage devices 18 via the network 16. As shown in FIG. 1, according to various embodiments, each respective storage device 18 may form a portion of each respective computing system 14.

Each of the storage devices 18 includes a database having information regarding potential consumers, and such information may be present for any number of potential consumers. For one of the storage devices 18, the database may be a large database having information for approximately 230,000,000 potential consumers, wherein the information may include a plurality of data variables (e.g., behavioral, attitudinal and demographic/non-attitudinal) for each of the potential consumers, and wherein the information is appended to individual records/rows of data in a database table. In general, the large database may be a third party database maintained by a company such as, for example, Experian. The consumer data variables may relate to many different types of data. Behavioral variables reflect actions which have been taken by consumers in the past, as well as self-reported propensities to take certain actions in the future. Attitudinal variables reflect attitudes of the consumers such as, for example, brand loyalty, price sensitivity, importance of quality, preference for style, and attraction to brand proposition. Non-attitudinal variables are objective variables of each consumer that are not based on the purchasing attitudes of the consumer. Such non-attitudinal variables include, for example, gender, income, age, home-ownership, parenthood, education, geographic location, ethnicity, etc.

For another of the storage devices 18, the database may be a smaller database having various pieces of information, including media usage information, for approximately 60,000 consumers. In general, the smaller database may be a third party database maintained by companies such as Simmons, MRI, etc. The information in the smaller database may be organized into categories such as, for example, media usage, lifestyle, demographic, financial, home-ownership, vehicle registration, consumer purchase behavior variables, etc.

As the system 10 is communicably connected to the storage devices 18, lists of potential consumers, including information associated with the consumers, may be accessed by the system 10. Although only two computing systems 14 and storage devices 18 are shown in FIG. 1, it will be appreciated that the system 10 may be communicably connected to any number of such computing systems 14 and storage devices 18, with each storage device 18 including any number of such databases. Also, although the Experian database was described as an example of a large database and the Simmons and MRI databases were described as examples of a smaller database, it will be appreciated that the respective storage devices 18 may include large and/or smaller databases other than the Experian, Simmons and MRI. However, for purposes of simplicity, the large database will be referenced as the Experian database and the smaller database will be referenced as the Simmons database hereinafter.

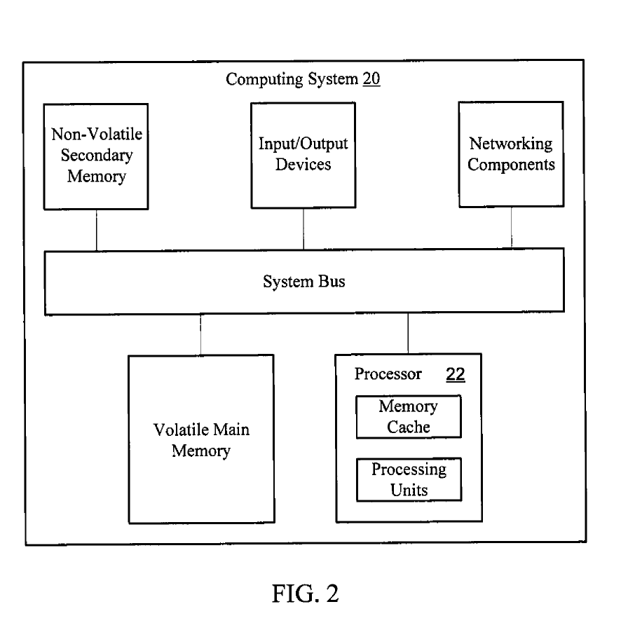

As shown in FIG. 1, the system 10 includes a computing system 20. The computing system 20 may include any suitable type of computing device (e.g., a server, a desktop, a laptop, etc.) that includes at least one processor 22. Various embodiments of the computing system 20 are described in more detail hereinbelow with respect to FIG. 2.

According to various embodiments, the system 10 includes at least the following modules: a matching model 24, a scoring module 26, a ranking module 28 and a comparison module 30. Of course, as described hereinabove, the system 10 may also include the targeting engine 12 which may be embodied as a module. Each of the modules 24-30 (as well as the targeting engine 12) may be communicably connected to the processor 22 and to one another. Additionally, the system 10 may also include other modules such as, for example, those described in U.S. patent application Ser. No. 13/020,967, the contents of which are incorporated by reference herein in their entirety.

The matching module 24 is configured to match consumers listed in the Simmons database with corresponding entries for those consumers in the Experian database. According to various embodiments, the matching module 24 performs the matching by taking information for the respective consumers in the Simmons database (names, addresses, etc.) and matching the information with corresponding entries for those same consumers in the Experian database. According to various embodiments, the matching module 24 is also configured to append all of the independent variables appended to the individual rows/records of the matched consumers in the Experian database to the corresponding individual rows/records of those same consumers in the Simmons database. According to other embodiments, the matching module 24 is also configured to append to the individual rows/records of the consumers in the Simmons database only those independent variables which are to be utilized by the one or more algorithms generated by a targeting engine 12.

The scoring module 26 is configured to calculate a score for each consumer listed in the Simmons database. According to other embodiments, the scoring module 26 may be configured to only calculate a score for a portion of the consumers listed in the Simmons database (e.g., preselected consumers who fall within an advertiser's demographic target). The score for a given consumer is an indication of how well the given consumer fits a desired target profile (e.g., attitudinal, attitudinal and behavioral, etc.). In general, the scoring module 26 utilizes the one or more algorithms generated by the targeting engine 12 to calculate the respective scores. The scoring module 26 may utilize the one or more algorithms generated by the targeting engine 12 (or by any number of different targeting engines 12) to calculate any number of different scores (one per algorithm) for a given consumer in the Simmons database. According to various embodiments, the functionality of the scoring module 26 may be incorporated into a scoring module of the targeting engine 12.

The ranking module 28 is configured to rank the consumers listed in the Simmons database based on the scores calculated with a given targeting engine algorithm by the scoring module 26. For embodiments where scores were calculated for only a pre-selected portion of the consumers listed in the Simmons database, the ranking module 28 is configured to rank only those consumers. For embodiments where more than one score was calculated for each consumer (due to more than one targeting engine algorithm being utilized), the ranking module 28 is further configured to rank the scores on a “targeting engine algorithm by targeting engine algorithm” basis. According to various embodiments, for the scores calculated with a given targeting engine algorithm by the scoring module 26, the ranking may be ordered from the highest score to the lowest score. According to other embodiments, the ranking may be ordered from lowest score to the highest score. It will be appreciated that a first ranking based on scores calculated using a first targeting engine output may be different than a second ranking based on scores calculated using a second targeting engine output. In general, the rankings indicate the relative likelihood that a given consumer will take a particular action such as, for example, purchasing a particular product (e.g., a good or a service) within a specified period of time, because they are more likely to reflect the marketer's optimal prospect attitudinal profile. According to various embodiments, the functionality of the ranking module 28 may be incorporated into a ranking module of the targeting engine 12.

The comparison module 30 is configured to compare the media behavior of a portion (e.g., a predetermined number, a predetermined percentage, etc.) of the top-ranked consumers in the Simmons database with all of the consumers in the Simmons database. According to other embodiments, the comparison module 30 is configured to compare the media behavior of a portion of the top-ranked consumers in the Simmons database with all of the consumers in the Simmons database who are within the targeted demographic. The comparison module 30 may perform the comparison on an item-by-item basis such as, for example, a magazine-by-magazine basis, a television show-by-television show basis, etc. For the television show-by-television show basis, the comparison module 30 may take, for example, the top 20% of the ranked consumers of the Simmons database (e.g., 20% of 60,000 consumers=12,000 consumers) and compare their media behavior to all of the consumers in the Simmons database (e.g., 60,000 consumers). The comparison may be realized by determining, for example, (1) the percentage of the 12,000 consumers (i.e., the top 20% of the ranked consumers in the Simmons database) who watched Oprah last week and (2) the percentage of the 60,000 consumers (i.e., all the consumers in the Simmons database) who watched Oprah last week. Based on the determination of the respective percentages of consumers who watched Oprah last week, the comparison module 30 determines a ratio which indicates how efficiently each television program delivers the targeted profile audience. If the determined ratio for a particular television program has a value greater than one, the television program should be considered to deliver an above-average percentage of the target segment consumer.

The modules 24-30 (as well as the targeting engine 12) may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 24-30 (e.g., software application, computer program) may be stored on a computer-readable medium (e.g., disk, device, and/or propagated signal) such that when a computer reads the medium, the functions described herein are performed. According to various embodiments, the above-described functionality of the modules may be combined into fewer modules, distributed differently amongst the modules, spread over additional modules, etc.

FIG. 2 illustrates various embodiments of the computing system 20. The computing system 20 may be embodied as one or more computing devices, and includes networking components such as Ethernet adapters, non-volatile secondary memory such as magnetic disks, input/output devices such as keyboards and visual displays, volatile main memory, and a processor 22. Each of these components may be communicably connected via a common system bus. The processor 22 includes processing units and on-chip storage devices such as memory caches.

According to various embodiments, the computing system 20 includes one or more modules which are implemented in software, and the software is stored in non-volatile memory devices while not in use. When the software is needed, the software is loaded into volatile main memory. After the software is loaded into volatile main memory, the processor 22 reads software instructions from volatile main memory and performs useful operations by executing sequences of the software instructions on data which is read into the processor 22 from volatile main memory. Upon completion of the useful operations, the processor 22 writes certain data results to volatile main memory.

FIG. 3 illustrates various embodiments of a method 50. As explained in more detail hereinbelow, the method 50 may be utilized to provide guidance to an entity (e.g., an advertiser) considering one or more media purchases. According to various embodiments, the method 50 may be implemented by the system 10. For purposes of simplicity, the method 50 will be described in the context of its implementation by the system 10. However, it will be appreciated that the method 50 may be implemented by any number of different systems.

Prior to the start of the process, a large amount of information associated with potential consumers is developed and organized as respective databases residing at the storage devices 18. The information includes a plurality of data variables for potential customers, and the databases may be of different sizes and include different amounts of information. Although the smaller databases (e.g., the Simmons database) include information on fewer consumers, the information may be more targeted (e.g., may include media usage information) than the information included on the larger database (e.g., the Experian database). The information may include any number of such data variables, including behavioral variables, attitudinal variables, and non-attitudinal variables. Such data variables may relate to any number of different types of data. The data variables may be organized into categories such as, for example, media usage, lifestyle, demographic, financial, home-ownership, vehicle registration, consumer purchase behavior variables, etc. A person skilled in the art will appreciate that the respective databases may include many different types of consumer data variables. Additionally, the targeting engine 12 is developed as described, for example, in U.S. patent application Ser. No. 13/020,967, in U.S. patent application Ser. No. 12/869,441, in U.S. patent application Ser. No. 09/511,971, in U.S. Pat. No. 7,835,940, in U.S. Pat. No. 7,742,072, etc.

The process starts at block 52, where the matching module 24 matches the consumers listed in the Simmons database with corresponding entries for those consumers in the Experian database. According to various embodiments, the matching module 24 performs the matching by taking information for the respective consumers in the Simmons database (names, addresses, etc.) and matching the information with corresponding entries for those same consumers in the Experian database. The matching module 24 then appends the independent variables appended to the individual rows/records of the matched consumers in the Experian database to the corresponding individual rows/records of those same consumers in the Simmons database. According to other embodiments, the matching module 24 appends only those independent variables which are to be utilized by the targeting engine. According to various embodiments, all of the matching is performed then all of the appending is performed. According to other embodiments, the matching and appending is performed for one consumer, then for the next consumer, etc. Thus, it will be appreciated that portions of the matching and appending may be performed concurrently for different consumers.

From block 52 the process advances to block 54, where the scoring module 26 utilizes one or more of the algorithms developed by the targeting engine 12 to calculate a score for each consumer listed in the Simmons database. According to other embodiments, the scoring module 26 utilizes one or more of the algorithms developed by the targeting engine 12 to calculate a score for only a portion of the consumers listed in the Simmons database (e.g., preselected consumers who fall within an advertiser's demographic target). The score calculated for a given consumer at block 54, which is calculated based on the independent variables appended to the individual rows/records of the given consumer in the Simmons database, is a representation of that consumer's degree of fit with the desired consumer profile. In general, the targeting engine algorithm having the highest % lift is the algorithm which is utilized to calculate the scores for the consumers. Of course, according to various embodiments, algorithms developed by more than one targeting engine 12 may be utilized to calculate more than one set of scores for a given consumer.

From block 54, the process advances to block 56, where the ranking module 28 ranks all of the consumers listed in the Simmons database based on the scores calculated by the scoring module 26 at block 54. For embodiments where scores were calculated for only a pre-selected portion of the consumers listed in the Simmons database, the ranking module 28 is configured to rank only those consumers. For embodiments where more than one score is calculated at block 54 for each consumer, the ranking module 28 may generate a plurality of rankings for the consumers. For example, if the scoring module 26 utilizes three different targeting engine algorithms to calculate three different scores for each consumer in the Simmons database, the ranking module 28 may generate three different rankings for each consumer. In general, the rankings represent the relative likelihood that that the consumers will take a particular action such as, for example, purchasing a particular product (e.g., a good or a service) within a specified period of time.

From block 56, the process advances to block 58, where the comparison module 30 compares the media behavior of a portion (e.g., a predetermined number, a predetermined percentage, etc.) of the top-ranked consumers in the Simmons database with all of the consumers in the Simmons database to determine how efficiently each media property delivers the targeted profile audience. According to various embodiments, the comparison module 30 only compares the media behavior of a portion of the top-ranked consumers in the Simmons database with all of the consumers in the Simmons database who are within the targeted demographic. The comparison module 30 may perform the comparison on an item-by-item basis (e.g., a magazine-by-magazine basis, a television show-by-television show basis, etc.), and any number of such comparisons may be performed. In general, the comparison module 30 may take a given portion (e.g., 20%) of the top ranked consumers of the Simmons media usage database and compare their media behavior to all of the consumers in the Simmons database (or just to all of the consumers in the Simmons database who are within the targeted demographic). For example, when the item is a newspaper, the comparison may be realized by determining, for example, a ratio of (1) the percentage of the top ranked consumers who read the New York Times last week and (2) the percentage of all of the consumers in the Simmons database who read the New York Times last week. In general, for a given media property, if the determined audience delivery ratio has a value greater than one, the media property audience is delivering a higher than average ratio of the target profile audience.

The process described at blocks 52-58 may be repeated any number of times for any number of different media properties. It will be appreciated that based on the determined ratios for various media properties, an entity can make an informed, optimized media purchase (e.g., based on the “adjusted” cost per 1000 consumers who fit the target audience profile instead of based on the traditional cost per 1000 consumers who merely fall within a demographic target definition).

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

1. A system, comprising:
a computing device, wherein the computing device comprises a processor;
a matching module communicably connected to the processor, wherein the matching module is configured to match information in a first database with corresponding entries in a second database, wherein the second database is larger than the first database;
a scoring module communicably connected to the processor, wherein the scoring module is configured to utilize a targeting engine to calculate a score for at least a portion of the consumers in the first database;
a ranking module communicably connected to the processor, wherein the ranking module is configured to rank at least a portion of the consumers in the first database based on the calculated scores; and
a comparison module communicably connected to the processor, wherein the comparison module is configured to compare media behavior of a first group of ranked consumers in the first database with media behavior of a second group of consumers in the first database.

2. The system of claim 1, wherein the matching module is configured to match a name of a consumer in the first database with the name of the same consumer in the second database.

3. The system of claim 1, wherein the matching module is configured to match an address of the consumer in the first database with the address of the same consumer in the second database.

4. The system of claim 1, wherein the matching module is further configured to append at least one independent variable appended to a record of a consumer in the second database to a record of the same consumer in the first database.

5. The system of claim 1, wherein the scoring module is configured to calculate the respective scores for the consumers in the first database by utilizing an algorithm generated by the targeting engine.

6. The system of claim 1, wherein the scoring module forms at least a portion of the targeting engine.

7. The system of claim 1, wherein the ranking module is configured to rank the at least a portion of the consumers in the first database from highest to lowest based on the calculated scores.

8. The system of claim 1, wherein the ranking module is configured to rank the at least a portion of the consumers in the first database from lowest to highest based on the calculated scores.

9. The system of claim 1, wherein the ranking module forms at least a portion of the targeting engine.

10. The system of claim 1, wherein the first group comprises one of the following:
a predetermined number of the highest ranked consumers in the first database;
a predetermined number of the lowest ranked consumers in the first database;
a predetermined percentage of the highest ranked consumers in the first database; and
a predetermined percentage of the lowest ranked consumers in the first database.

11. The system of claim 1, wherein the second group comprises one of the following:
all of the consumers in the first database; and
a predetermined number of the consumers in the first database;
a predetermined percentage of the consumers in the first database;
all of the consumers in the first database who fall within a targeted profile;
a predetermined number of the consumers in the first database who fall within the targeted profile; and
a predetermined percentage of the consumers in the first database who fall within the targeted profile.

12. A method, implemented at least in part by a computing device, the method comprising:
matching information in a first database with corresponding entries in a second database, wherein the second database is larger than the first database;
utilizing a targeting engine to calculate a score for at least a portion of the consumers in the first database;
ranking at least a portion of the consumers in the first database based on the calculated scores; and
comparing media behavior of a first group of ranked consumers in the first database with media behavior of a second group of consumers in the first database, wherein the matching, calculating, ranking and comparing are performed by the computing device.

13. The method of claim 12, wherein the matching comprises matching a name of a consumer in the first database with the name of the same consumer in the second database.

14. The method of claim 12, wherein the matching comprises matching an address of the consumer in the first database with the address of the same consumer in the second database.

15. The method of claim 12, wherein the matching further comprises appending at least one independent variable appended to a record of a consumer in the second database to a record of the same consumer in the first database.

16. The method of claim 12, wherein the calculating the respective scores comprises calculating the respective scores for the consumers in the first database by utilizing an algorithm generated by the targeting engine.

17. The method of claim 12, wherein calculating the respective scores comprises calculating a score for each consumer in the first database.

18. The method of claim 12, wherein the ranking comprises ranking the at least a portion of the consumers in the first database from highest to lowest based on the calculated scores.

19. The method of claim 12, wherein the ranking comprises ranking the at least a portion of the consumers in the first database from lowest to highest based on the calculated scores.

20. The method of claim 12, wherein ranking comprises ranking each of the consumers in the first database based on the calculated scores.

21. The method of claim 12, wherein comparing the media behavior of the first group of ranked consumers with the media behavior of the second group of consumers comprises comparing at least one of the following with the media behavior of the second group:
media behavior of a predetermined number of the highest ranked consumers in the first database;
media behavior of a predetermined number of the lowest ranked consumers in the first database;
media behavior of a predetermined percentage of the highest ranked consumers in the first database; and
media behavior of a predetermined percentage of the lowest ranked consumers in the first database.

22. The method of claim 12, wherein comparing the media behavior of the first group of ranked consumers with the media behavior of the second group of consumers comprises comparing the media behavior of the first group with the media behavior of at least one of the following:
all of the consumers in the first database; and
a predetermined number of the consumers in the first database;
a predetermined percentage of the consumers in the first database;
all of the consumers in the first database who fall within a targeted profile;
a predetermined number of the consumers in the first database who fall within the targeted profile; and
a predetermined percentage of the consumers in the first database who fall within the targeted profile.
